(19) United States
(12) Patent Application Publication
(10) Pub. No.: US 2025/0070513 A1
(43) Pub. Date: Feb. 27, 2025

(54) PASS-THROUGH CONNECTOR WITH LOCKING ELEMENT

(71) Applicant: Aptiv Technologies AG, Schaffhausen (CH)

(72) Inventors: Gildas DONFACK, Etrechy (FR); ShobanKumar Baskaran, Ramanathapuram (IN)

(21) Appl. No.: 18/811,684

(22) Filed: Aug. 21, 2024

(30) Foreign Application Priority Data
Aug. 22, 2023 (EP) 23192761.7

(51) Int. Cl. H01R 13/639; H01R 13/502; H01R 13/627; H01R 13/73; H01R 43/20; H01R 103/00

(52) U.S. Cl. CPC H01R 13/639; H01R 13/502; H01R 13/6273; H01R 13/73; H01R 43/20; H01R 2103/00; H01R 2201/26

(57) ABSTRACT

A pass-through connector system for wall installation includes an electrical terminal for connection with a counter-terminal of a mating connector. The connector features an inner head and an outer head designed to be joined across a wall or shield orifice, with an outer hooking member on the outer head and an inner hooking member on the inner head engaging to secure the heads together. A movable locking element on the inner head transitions between locked and unlocked positions, with assistance members facilitating disengagement of the hooking members. This innovative design allows for secure mating with a counter-connector while enabling easy disassembly for maintenance or reconfiguration.

### CROSS-REFERENCE TO RELATED APPLICATION

This application claims the benefit of and priority to European Patent Application No. 23192761.7 titled “Pass-Through Connector with Locking Element” filed on Aug. 22, 2023, the contents of which are incorporated by reference herein.

### TECHNICAL FIELD

The present disclosure relates to the field of connectors, and in particular to the field of automotive connectors.

### BACKGROUND

Connectors are used to assemble several previously made elements in order to make a connection between them that allows electrical energy and/or signals to be transmitted between these elements. These elements can each be a cable or a motor or another type of device such as a computer or a sensor or a lighting device. According to the application, such connectors may have electrical contacts in greater or lesser number and in greater or lesser size.

When the connector mounted on one cable is mated with another connector, which can be called a counter-connector, usually of a different and for example complementary type, its electrical contacts are themselves mated with corresponding counter contacts on the other side of the connection that are mounted in the counter connector.

“Pass-through” connectors are used for connecting a cable with a non-flexible device, such as with a motor for powering it or with a whole electrically powered vehicle for charging its battery.

Such a pass-through connector commonly includes an inner part and an outer part, on both sides of a wall and which are assembled together through an opening of the wall. Inner and outer are here conventionally used for meaning inner and outer sides of an enclosure, but the present disclosure is also applicable to the opposite configuration.

FIG. 1 and FIG. 2 show an example of a prior art pass-through connector 9, including an inner head 91 to be assembled through a customer interface, called shield, 94 with an outer head assembly 92, 93. The shield 94 is to be fixed to a non-represented wall with fixation means that may be known ones, or to be integral with the wall.

The inner head received several electrical terminals 911 that are fixed to the end of cables 912. Such cables are for example connected with the terminals of a non-represented power battery.

It is to be noted that the whole assembly shown in FIG. 1 is only one connector, a connector fixed to a wall, and which is then ready to be mated with a counter connector (which counter connector is not represented in FIG. 1).

The outer part includes an outer head 93 with a fixation and shielding sleeve 92 and is arranged to be assembled with the inner head 91. Outer head 93 forms a socket which it is assembled with the shield 94 and bears cooperation means for ergonomically receiving a counter connector 8. Such cooperation means typically include poka-yoke guides 931 and retention protrusions 932 for the counter connector.

In such prior art, inner head 91 is retained inside the by retention lances 914, integral with fixation sleeve 92, that clips itself in a small cavity on the external surface of the inner head 91. As illustrated in FIG. 1b, fixation sleeve 92 also includes retention lances 923 that come into abutment with the outer head 93, hence preventing back movement of the inner head 91 out of outer head 93.

Thus, as illustrated in FIG. 2, disassembling the connector 9 may only be done by bending the retention lances 914 away from the inner head 91, which operation requests use of a long and thin tool 90 such as a screwdriver, to be inserted between inner head 91 and shield 94. This is true for each of the retention lances, typically four of them which must moreover be actuated concurrently.

Hence, in the prior art, pass-through outer header and inner header are difficult to disassemble from each other once they have been assembled together. Serviceability is made difficult for the final assembly, and thus for the entire system or vehicle it is used into. Also, such fixation by lances 914 click-snapping is not very dependable for ensuring that retention is actually obtained and is difficult to access for completion if retention is not completely produced by the sole insertion of the inner head.

Previous approaches to pass-through connectors for walls have typically involved fixed connectors that are permanently attached to the wall, making it difficult to remove or replace the connector without damaging the wall or the connector itself. These fixed connectors often lack flexibility in terms of accommodating several types of counter-connectors or terminals, limiting their versatility and usability in various applications. Additionally, the fixed connectors may not provide a secure locking mechanism to prevent accidental disconnection or unauthorized access, leading to potential safety and security concerns.

Some existing pass-through connectors utilize complex locking mechanisms that require multiple steps to assemble and disassemble, making them cumbersome and time-consuming to use. These connectors may also lack user-friendly features, such as clear indicators for the locked and unlocked positions, leading to potential errors in operation. Furthermore, the locking mechanisms in these connectors may not provide sufficient stability and durability, resulting in potential wear and tear over time, reducing the overall reliability of the connector.

Other pass-through connectors may incorporate hooking members for securing the heads together, but these hooking members may lack a reliable locking element to prevent unintentional disengagement. Without a robust locking mechanism, the heads of the connector may become loose or detached, leading to signal loss or electrical disconnection. Moreover, the absence of assistance members in the locking element may hinder the case of disengaging the hooking members, making it challenging to remove the connector when needed. However, none of these approaches have provided a comprehensive solution that combines the features described in this disclosure.

One aim of the disclosure is to overcome some or all of the disadvantages of the prior art. In particular, it is intended to make assembling and disassembling of the pass-through connector easier, quicker, and more dependable, especially for non-specialist operators.

### SUMMARY

These objectives are achieved partially or wholly, according to the disclosure, by a device and method having the features set forth in the claims. The disclosure below provides a solution for at least partially mitigating these drawbacks. The claims form an integral part of the technical description provided herein in connection with the disclosure.

Such a pass-through connector, which is configured to be mated with a counter-connector, includes a first head, hereafter referred to as an inner head, and a second head, hereafter referred to as an outer head, configured for being assembled with each other from either sides of a wall and across a possibly closed orifice of a shield and/or a wall, so as to bear the terminals and to be mated with the counter-connector.

According to the disclosure, the pass-through connector includes an outer hooking member on the outer head, and an inner hooking member on the inner head that are arranged for engaging together for retaining the inner and outer heads together once in their assembled positions. The pass-through connector includes a locking element, mounted on the inner head, movable between at least an unlocked position allowing assembling both heads together and a locked position preventing hooking members from disengage from each other, preferably by manual-only operation. Locking element further includes one or several assistance members, which cooperates with at least one of the hooking members for disengaging the hooking members from one another, when the locking element is moved from its locked position to its unlocked position.

Thanks to these provisions, disassembling and serviceability are made possible and easier, and more ergonomically, even if the rear side provides little or difficult access. Installation is also made easier and more dependable with little or no loss of compactness. Implementation in various systems or vehicles is made easier and more flexible, and with less design constraints.

Its advantages are ease of installation and better serviceability from the rear side as well the area with difficult access. The use of the CPA guarantees the functionality of the lock and acts as a secondary lock. It is ergonomic and the disassembly is done by deactivating the CPA.

### BRIEF DESCRIPTION OF THE DRAWINGS

Further features and advantages will become apparent in the detailed disclosure of an example embodiment of a connector assembly, as well as variations of this embodiment, this disclosure being accompanied by references to the accompanying drawings.

FIG. 1 is a schematic diagram showing an exploded view the components of a pass-through connector according to the prior art.

FIG. 1b is a schematic diagram showing a detail of the connector of FIG. 1, once assembled, with the outer head removed for more clarity according to the prior art.

FIG. 2 is a schematic diagram in longitudinal cut view showing the whole and a detail of the pass-through connector of FIG. 1 when assembled on the shield and mated with a schematically represented counter connector according to the prior art.

FIG. 3 is a schematic diagram showing the components of a pass-through connector in exploded view and in isometric of the assembled connector illustrated with a schematized counter-connector according to some embodiments.

FIG. 4 is an isometric view of the locking element of the embodiment of FIG. 3 according to some embodiments.

FIG. 5 is a detailed isometric top view of a horizontal cut of the locking part of the inner head of the embodiment of FIG. 3 according to some embodiments.

FIG. 6 is the same view as FIG. 5 with the locking element assembled with the inner head and in unlocked position according to some embodiments.

FIG. 7 is a detailed top view of the assembly of FIG. 6, still with the top wall removed according to some embodiments.

FIG. 8 is an isometric view of the outer head of the embodiment of FIG. 3 according to some embodiments.

FIG. 9 is a front view of a longitudinal central cut of the connector of FIG. 3, before being assembled together according to some embodiments.

FIG. 10 is a front view of a longitudinal central cut of the connector of FIG. 3, once assembled on the fixation wall and before locking according to some embodiments.

FIG. 11 is a detailed front view of a longitudinal central cut of the connector of FIG. 3, during the process of moving in the locking element according to some embodiments.

FIG. 12 is a detailed front view of a longitudinal cut of the connector of FIG. 3, in locked position, showing a central cut according to some embodiments.

FIG. 13 is a detailed front view of a longitudinal cut of the connector of FIG. 3, in locked position, showing an offset cut according to some embodiments.

FIG. 14a and FIG. 14b are detailed front views of a longitudinal cut of the connector of FIG. 3, in the process of extracting the locking element from its locked position, in the step of unlocking the locking element from the inner head, with a central cut and with an offset cut according to some embodiments.

FIG. 15a and FIG. 15b are detailed front views of a longitudinal cut of the connector of FIG. 3, in the process of extracting the locking element from its locked position, in the further step of the locking element assisting the unlocking of the inner head from the outer head, with a central cut and with an offset cut according to some embodiments.

FIG. 16 is a front view of a longitudinal central cut of the connector of FIG. 3 once it has been unlocked and in the process of separating inner head from outer head according to some embodiments.

FIG. 17 is a detailed front view of a longitudinal central cut of the connector of FIG. 3, in a situation where the locking element is preventing from being locked by the inner head being not completely inserted in the outer head according to some embodiments.

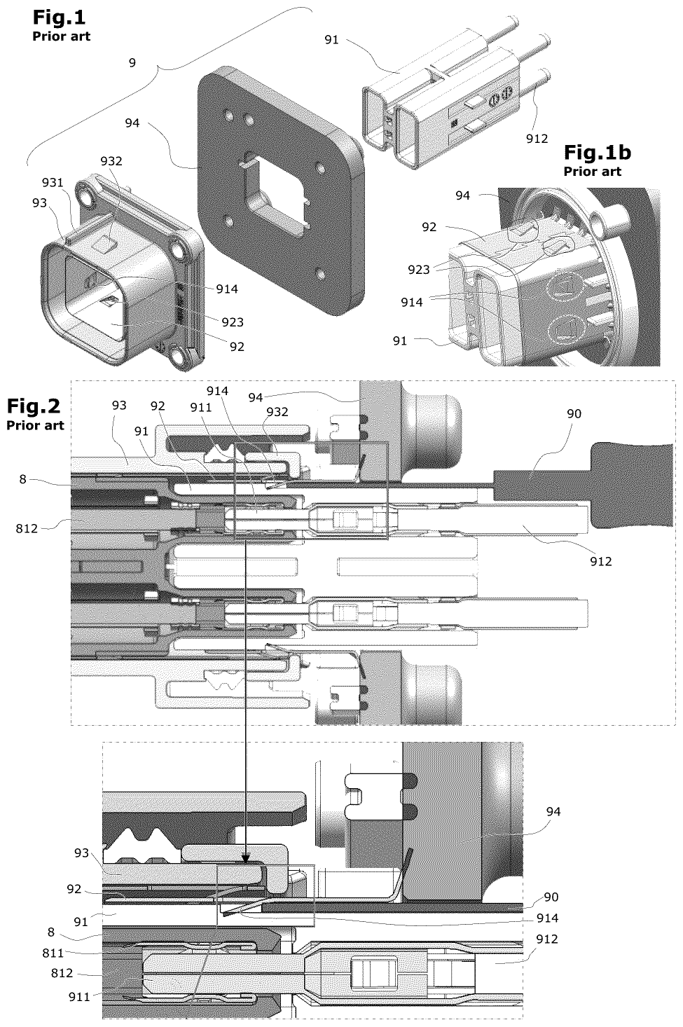

### DETAILED DESCRIPTION

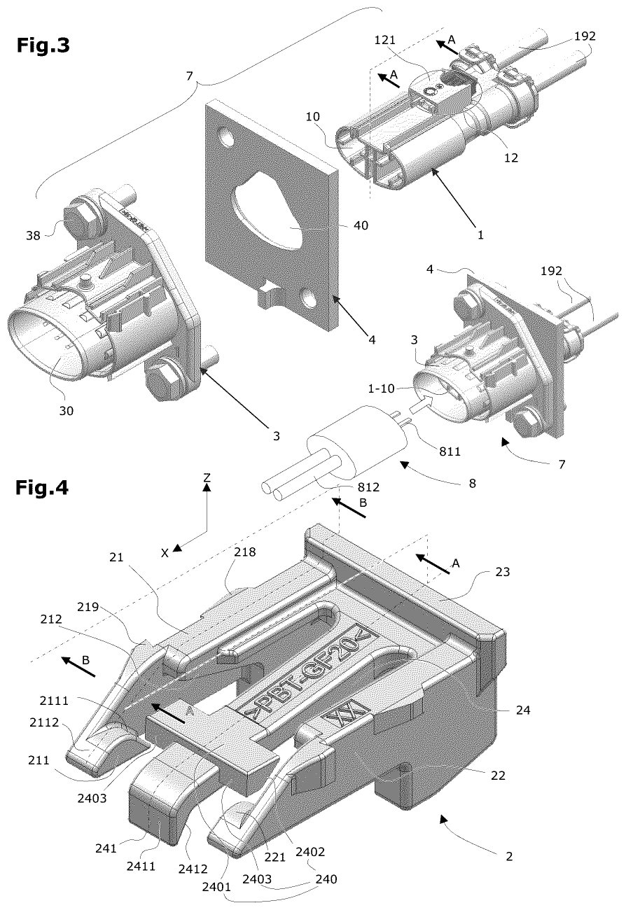

FIGS. 3 to 15 show a non-limiting example of a pass-through connector 7 according to the present disclosure. In the various figures, similar or identical elements have the same references.

As illustrated in FIG. 3, the pass-through connector 7 includes an outer head 3 receiving and assembled with an inner head 1 across a shield 4 that may be fixed to or integral with a wall. At its mating extremity, inner head 1 has a double longitudinal cavity 10 in which are mounted two electrical terminals, possibly of a known type and not visible here. These terminals are fixed on two to-be-connected cables 192. The mating extremity of inner head 1 is to be inserted through the shield 4 and then into a longitudinal cavity 30 of the outer head 3. Once assembled, with the outer head 3 fixed to the shield such as by screws 38, the connector 7 forms a wall socket that can receive a counter connector 8 with its own cables 812, the counter connector 8 being guided within the outer head cavity 30 with its counter terminals 811 mated with the terminals of the inner head 1.

In such mated assembly, counter-connector 8 preferably includes a locking mechanism and a “connection position assurance” system (CPA), between the counter connector 8 and the connector 7, that are not illustrated here, independently and in supplement of the present disclosure.

It should be noted that such counter connector 8 could possibly be the same as in the prior art, with the same locking mechanism and CPA, as the shape of the inner head 1 and outer head 3 of the present connector 7 are not directly constrained by the functional features of the present disclosure, and could easily be configured for compatibility with the shape of such counter connector.

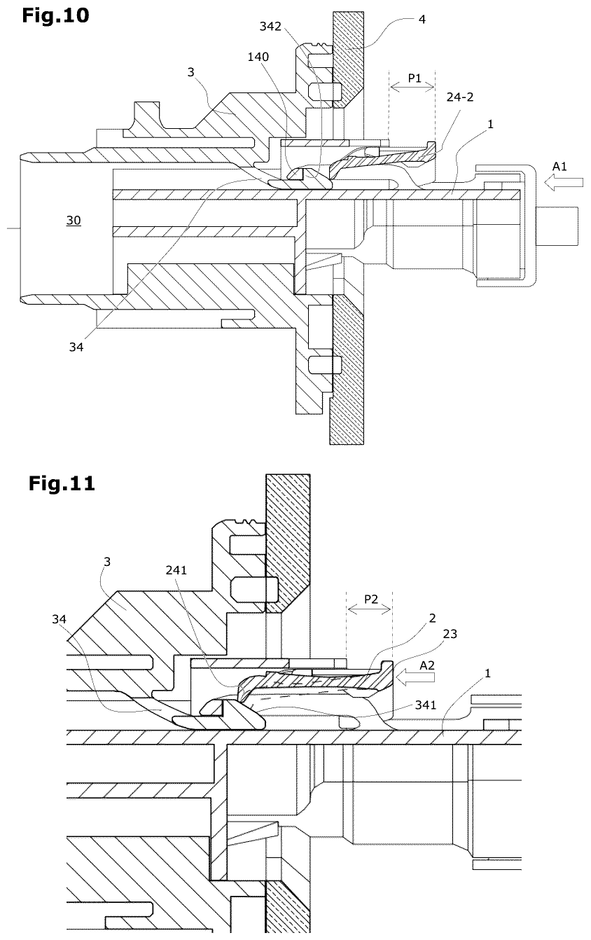

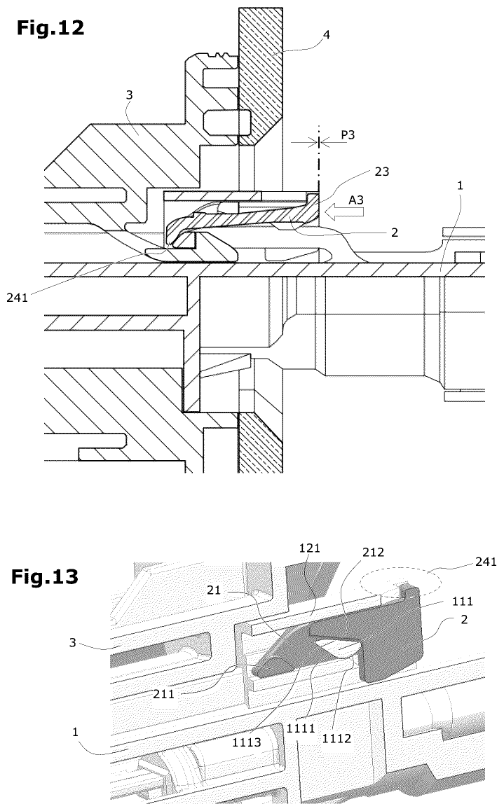

According to the present disclosure, inner head 1 includes itself a locking area 12, in which is mounted a locking element 2 that is slidably movable between an unlocked position (see FIG. 6, FIG. 9 and FIG. 10) and a locked position (see FIG. 12 and FIG. 13).

As illustrated in FIG. 4, locking element 2 is a one-piece separated element, which is inserted into a longitudinal cavity included in the top part of the inner head 1. Locking element 2 includes a transversal rear plate 23, from which longitudinally extends an assurance member, here embodied as a flexible central assurance arm 24, and two lateral locking arms 21, 22. The two lateral locking arms 21, 22 each have two guiding protrusions 218, 219 which are guided by longitudinally grooves of the locking area 12 of inner head 1. One 219 of the protrusions of the locking arms 21, 22 further have a hook shape that enables retaining the locking element 2 into the grooves 123 of locking area 12 by abutments 122.

In FIG. 4 is noted an orientation referential, used in the present disclosure, illustrating directions X for all “forward” directions and Z for all “upward” directions.

Assurance arm 24 is elastically deformable in the vertical direction and has on its free extremity a bottom oriented nose 241 with an external flat transverse forward oriented surface 2411 and a bottom-rear oriented slope 2412. Assurance arm 24 also has within its length a transverse protrusion 240 on both sides with a top oriented surface 2401, two lateral bottom-rear oriented slopes 2402, and two forward oriented surfaces 2403.

Lateral locking arms 21, 22 are elastically deformable in the horizontal direction toward the interior, i.e. toward the central assurance arm 24. Each has on its free extremity an assistance cam 211, 221, laterally protruding toward interior, with a top-rear oriented slope 2111 and preferably a top-forward oriented slope 2112. Each locking arm 21, 22 also has on its internal part a lateral interior-oriented closing protrusion 212, with a forward-bottom oriented slope.

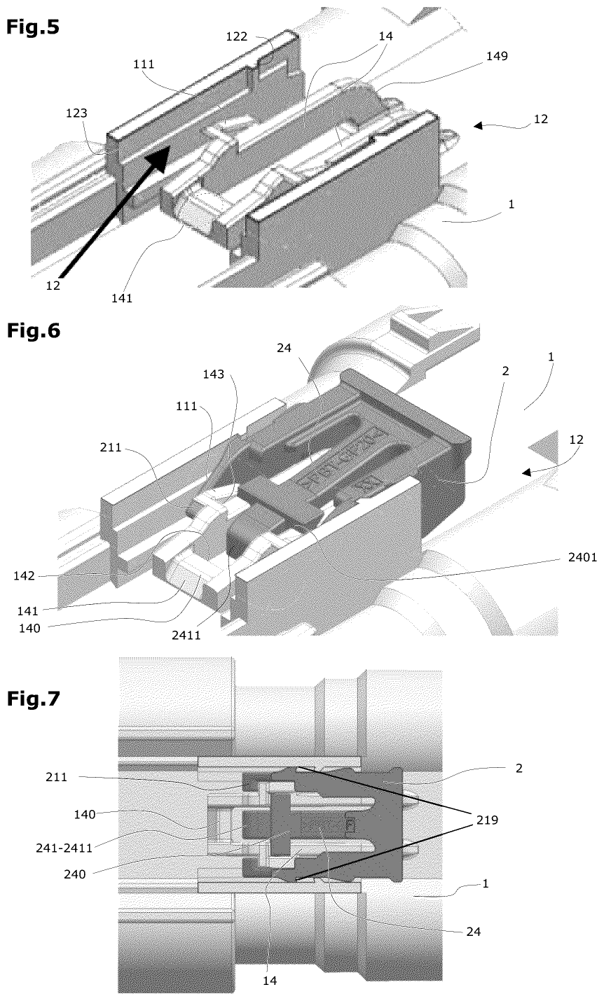

FIG. 5 and FIG. 6 show the interior of the locking area 12 of the inner head 1, with a horizontal cut so as to virtually remove its top wall 121. Locking area 12 includes a flexible hooking loop 14 with a hooking bridge 140 between two parallel branches that horizontally extend from the top surface of the inner head 1, through an elastically deformable joint 149 that enables the hooking bridge 140, at the free extremity of the hooking loop 14, to be uplifted.

Between its two branches, the free extremity of hooking loop 14 has a top-front oriented slope 141 and a rear oriented vertical abutment surface 142. Each branch of the hooking loop 14, on its lateral external face, has a lateral assistance protrusion 111. As visible on FIG. 13, aid assistance protrusion 111 has a forward-bottom oriented slope 1111, a rear-bottom oriented slope 1112 and a top-rear oriented slope 1113.

FIG. 6 shows, still with top wall 121 removed, the locking element 2 once inserted in the grooves of inner head 1 and in unlocked position.

The nose 240 of its assurance arm 24 is inserted between the two branches of hooking loop 14 of inner head and may slide between them. Both extremities of its transverse protrusion 240 overlap the branches of the hooking loop 14 of inner head. Each assistance cam 211, 221 of lateral of locking arms 21, 22 of locking element 2 is under its respective lateral assistance protrusion 111 of the hooking loop 14 of inner head and can longitudinally slide under it.

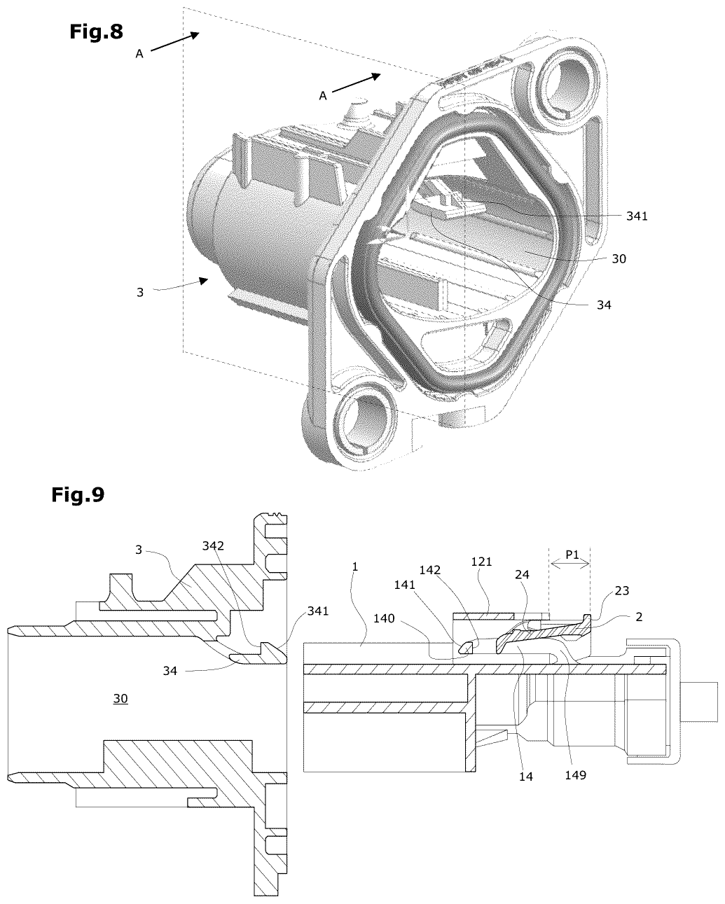

As illustrated in FIG. 8 and FIG. 9, outer head 3 has, in its longitudinal through cavity 30, a longitudinally oriented arm with a fixed hook 34 that extends toward the inner head 1. It has a vertical and transverse retention surface 342, arranged for retaining the rear oriented vertical abutment surface 142 of the bridge 140 of the hooking loop 14, when the inner head 1 is fully inserted into the outer head 3, as visible in FIG. 9. Fixed hook 34 of outer head also ends in a top-rear oriented slope 341.

FIG. 9 to FIG. 13 schematically show the process of assembling the connector 7.

All views of a “central cut” show a longitudinal vertical cut along a median plane AA, going through the fixed hook 34 and hooking bridge 140, as indicated in FIG. 4 and FIG. 8. All views of an “offset cut” show un longitudinal vertical cut along a thereto parallel plane BB, offset from central plane AA and going through the assistance protrusions 111 of inner head and assistance cams 211 and closing cam 212 of locking element 2.

In FIG. 9, inner head 1 is already provided with the locking element 2 in its unlocked position and is presented at the entrance of the opening 40 of shield 4 and at entrance of cavity 30 of the inner head 3.

In FIG. 10, inner head 1 has been inserted A1 and is assembled with outer head 3. Its hooking bridge 140 has been uplifted by the slope 341 of the fixed hook 34, and then elastically came down against the retention surface 342 of the fixed hook 34. Locking element 2 is still in unlocked position and protrudes out of the top wall 121 by a distance P1.

In FIG. 11, locking element 2 is pushed A2 toward outer head 3 and under top wall 121, protrusion distance of the rear plate 23 is reduced to P2. By this movement A2, the nose 241 of the assurance arm 24 of locking element 2 is being uplifted by the raising slope 341 of the fixed hook 34 of outer head 3. Its previous position is here illustrated in dashed line.

In FIG. 12, locking element 2 is fully pushed and its rear plate 23 comes in abutment against the edge of the top wall 121 of the locking area 12 of inner head 1. Its nose 241 has come back down under elasticity of the assurance arm 24, and/or possibly being pushed back by an optional downward slope (not represented here) extending from under the top wall 121. Protrusion distance P3 of the rear plate 23 has been reduced to its minimum, preferably zero. Such distance P3 is then a clearly visible indicator that the locking element 2 has been fully inserted and is now in its locked position.

As can be seen in FIG. 13 with an offset cut, the inferior surface of the closing protrusions 212 of the locking arms 21 come in contact with the top of the top-rear oriented slope 1113 of the assistance protrusion 111 of the hooking loop of the inner head. While this functionality could be seen as optional, this contact makes sure that the hooking loop 14 has actually come back down, so as to be fully retained by the fixed hook of the outer head 3. It also forcibly maintains the hooking loop in its down position behind the fixed hook 34, thus effectively locking the inner head I assembled with the outer head 3.

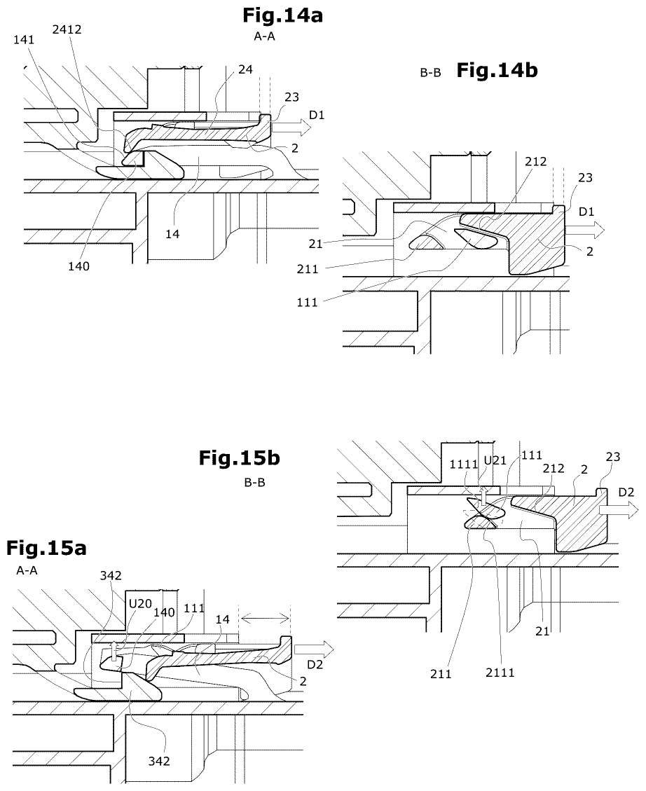

FIG. 14a to FIG. 15b schematically show the process of disassembling the connector 7, such as for service on the finished system or vehicle. Disassembling is here illustrated starting from the situation of FIG. 12 and FIG. 13, where the outer head and inner head are assembled around and through the shield 4 and/or the wall and are locked together by the fully pushed locking element 2.

In FIG. 14a and FIG. 14b, a servicing operator starts pulling on the locking element 2 by its rear plate 23. In an unlocking step, a first part D1 of the backward movement of locking element drives upward the nose 241 of its assurance arm 24, by a contact cooperation of the nose 241 and its rear-bottom oriented slope 2412 with the top-front oriented slope 2412 of the hooking loop 14, as seen in FIG. 14a.

In FIG. 15a and FIG. 15b, pulling goes on in second movement part D2. As seen in FIG. 6b, the closing protrusion 212 of each locking arm 21, 22 of the locking element 2 has recoiled sufficiently to uncover both assistance protrusions 111 of the arms of the hooking loop 14, thus enabling the hooking loop to be uplifted. Then, simultaneously or offset, the recoil of the assistance cam 211 of each locking arm 21, 22 of locking element 2 comes in contact cooperation by its summit and its top-rear oriented slope 2111 with the bottom and the forward-bottom oriented surface 1111 of the assistance protrusion 111 of the locking arm 21 of the hooking loop 14, thus uplifting U21 the assistance protrusion 111. As seen in FIG. 15a, uplifting move U21 of assistance protrusion causes an uplifting of the free extremity of hooking loop 14 and hence an uplifting U20 of its bridge 140, so as to get it out and over the retention surface 342 of the fixed hook 34 of the outer head 3.

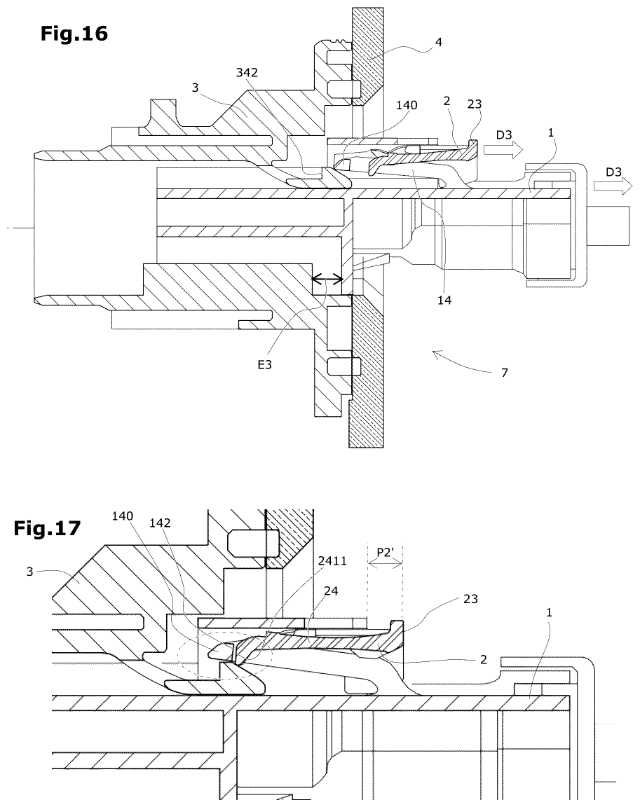

As illustrated in FIG. 16, it is then possible to extract the inner head 1 out of the outer head 3 by simply pulling D3 on it, as illustrated by the gap E3 growing between both parts 1,2 of the connector 7. It may be done by directly pulling on inner head 1, or simply by going on pulling on the rear plate 23 of the locking element 2, as its lateral locking protrusions 219 will transmit the traction effort to the inner head through the latter's abutment 122 within grooves of its locking area 12.

Thus, unlocking inner head 1 and separating it from outer head 3 maybe done simply, in one continuous movement, manually and without any tool for this whole disassembling operation.

FIG. 17 illustrates a situation where the inner head 1 has been assembled with the outer head 3, but where the hooking bridge 140 of the inner head 1 has not come down in full and correct contact with the retention surface 342 of the outer head 3. As it can be seen in the mixed-dashed line oval, the subsisting uplifted position of the hooking bridge 140 creates with its rear surface 142 an abutment for the front surface 2411 of the assurance arm 24 of the locking element 2, thus actually preventing it from being fully inserted under the top wall of the inner head. Also, or alternatively, the rear oriented surface 143 of the branches 14 of the hooking loop creates an abutment for the front surface 2403 of the transverse protrusion 240 of the assurance arm 24 of the locking element 2.

The remaining protrusion distance P2′ thus clearly shows to the operator that the connector 7 is not fully assembled and cannot be locked. Oppositely, a fully inserted locking element (with distance P3) makes it visibly certain that the connector is fully assembled and locked.

Disclosure thus provides better case and reliability of installation and better serviceability as well, from the rear side, even when this area happens to provide only difficult access.

While various cams 211 and protrusions 212 of locking element 2 are here exemplified in two instances distributed on two arms, it should be noted that other embodiments are also considered with more of them as well as with only one of each, as long as the same contact cooperation is arranged for each of here described functional surfaces and members. In the same spirit, similar variations of instances number are also considered for the assurance arm 24 and its nose 241 and slopes 2411, 2412. Similarly, hooking loop 14 is also considered with only one arm or more than two arms, and more than one “bridge” 140 and retention surface 342.

Also, it should be noted that the terms of “inner” and “outer” are not meant here as limitative and could be swapped depending on the context of implementation of the connector.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A pass-through connector, arranged to be fixed on both faces of a wall and configured for mating with a counter-connector, the connector comprising:
an electrical terminal configured for being removably connected with a counter-terminal of the counter-connector;
a first head called inner head and a second head called outer head, configured for being assembled with each other from either side of the wall and across a closed orifice of a shield and/or a wall, so as to bear the terminals and to be mated with the counter-connector,
an outer hooking member fixed to or extending from the outer head, and an inner hooking member fixed to or extending from the inner head, the hooking members are arranged to engage with each other so as to retains the heads together, once in their assembled positions;
a locking element which is mounted on the inner head so as to be movable, between at least an unlocked position, where it allows assembling both heads together and hooking both hooking members together, and a locked position, where it prevents the hooking members from disengage from each other, the locking element comprises one or several assistance members, that cooperates by contact with at least one of the hooking members for disengaging the hooking members from one another, when the locking element is moved from its locked position to its unlocked position.

2. The connector according to claim 1, wherein the locking element is movable, by manual-only operation.

3. The connector according to claim 1, wherein the hooking members are arranged for self-engaging with each other solely by movement of assembling together the inner head and the outer head, wherein the locking element is slidably mounted within a cavity formed in the inner head or between both heads, where it is arranged for being moved from its locked position to its unlocked position through a pulling movement, toward a second abutment position, and from its unlocked position to its locked position through a pushing movement that engage it into the cavity, until a first abutment position.

4. The connector according to the claim 3, wherein a clearly and unambiguously visible mark shows that the locking element is actually in its locked position.

5. The connector according to claim 1, wherein the inner hooking member may be moved toward a direction called “upward” so as to be disengaged from the outer hooking member, wherein the assistance member bears at least one assistance cam arranged for cooperating with a surface of the inner hooking member along a movement of the locking element from its locked position toward its unlocked position, so as to uplift the inner hooking member towards the upward direction and thus disengage it out of the outer hooking member.

6. The connector according to claim 1, wherein the inner hooking member may be moved toward a direction called “upward” so as to be disengaged from the outer hooking member, wherein the assistance member bears at least one closing surface arranged for cooperating with a surface of the inner hooking member when the locking element is in its locked position, so as to prevent the inner hooking member from being uplifted and thus preventing it to be disengaged from the outer hooking member.

7. The connector according to the claim 6, wherein the inner hooking member cooperates with the surface of the inner hooking member for driving it downwards into its engaged position when the locking element is moved from its unlocked position toward its locked position.

8. The connector according to claim 6, wherein the assistance member has at least a closing protrusion that bears the closing surface, and that is inserted between an assistance protrusion of the inner hooking member when the locking element is moved from its unlocked position toward its locked position, while the assistance member is itself prevented from uplifting by a fixed part of the inner head.

9. The connector according to claim 1, further comprising an assurance member provided with a nose which, when the locking element is moved from its unlocked position toward its locked position, is inserted between the inner hooking member and a fixed part of the inner head, wherein the nose has an forward abutment surface that comes in abutment with a rear abutment surface of the inner hooking member when the inner hooking member has not fully engaged with the outer hooking member.

10. The connector according to claim 1, wherein the inner hooking member has to be moved toward an “upward” direction so that an inner hooking part of it may travel over an outer hooking part of the outer hooking member, in particular raised by a fixed slope, when the locking element is moved toward its locked position, and where the inner hooking part has to be moved downward in order to come in abutment engagement with a retention surface of the outer hooking member, wherein an assurance member has an abutment surface that comes in abutment with a rear abutment surface of the inner hooking member when the inner hooking member has not fully moved over the outer hooking part, including its final downward movement of engaging with the retention surface.

11. The connector according to claim 10, wherein the assurance member comprises an assurance arm which is moved toward an “upward” direction in a same fixed slope as the hooking member, when the locking element is moved toward its locked position.

12. The connector according to claim 11, wherein the locking element is moved toward an “upward” direction by a front slope of the inner hooking part of the inner hooking member when the locking element is extracted from its locked position toward its unlocked position.

13. The connector according to the claim 9, wherein the assurance member and the assistance member are made as parallel separate arms extending toward the outer head from a same handling plate of the locking element, which is a stand-alone part slidably inserted within a pass-through and all-around closed cavity of the inner head.

14. The connector according to claim 1, wherein the outer head is configured to be fixed to a shield and/or wall, and the inner head bears all the electrical terminals, and the inner head is assembled to the outer head by being inserted and fixed into a pass-through cavity of the outer head.

15. The connector according to claim 14, wherein the inner head is fixed only to the outer head.

16. A connecting assembly, comprising:
the pass-through connector according to claim 1 fixed to a shield and/or a wall; and
a counter-connector mated with the pass-through connector.

17. A method for fixing a pass-through connector on a wall, comprising:
providing the pass-through connector according to claim 1, with its locking element in its unlocked position;
connecting the terminals of the pass-through connector with a cable;
assembling together the inner head and the outer head of the pass-through connector on both sides of the wall and across an orifice of the wall; and
locking the assembly by moving the locking element of the pass-through connector from its unlocked position to its locked position.

18. A method for disassembling a pass-through connector according to claim 1 from a shield and/or wall it is fixed to, comprising:
moving the locking element of the pass-through connector from its unlocking position towards its locking position, thus unlocking the inner hooking member;
further moving the locking element to its locking position, thus extracting the inner hooking member from its engaged position with the outer hooking member; and
extracting the inner head from the outer head, and then from the shield and/or wall.
